(19) United States
(12) Patent Application Publication
(10) Pub. No.: US 2013/0076313 A1
(43) Pub. Date: Mar. 28, 2013

(54) BATTERY CHARGING CONTROL TECHNIQUE FOR VEHICLE

(71) Applicants: Woo Sung Kim, Hwaseong (KR); Il Cho, Incheon (KR)

(72) Inventors: Woo Sung Kim, Hwaseong (KR); Il Cho, Incheon (KR)

(73) Assignees: KIA MOTORS CORPORATION, Seoul (KR); HYUNDAI MOTOR COMPANY, Seoul (KR)

(21) Appl. No.: 13/323,400

(22) Filed: Dec. 12, 2011

(30) Foreign Application Priority Data
Sep. 26, 2011 (KR) 10-2011-0096715

(51) Int. Cl. H02J 7/00

(52) U.S. Cl. 320/150

(57) ABSTRACT

Disclosed is a battery charging technique which prevents a battery from being deteriorated by controlling charging of the battery to a current rate appropriate for the current temperature environment in which the battery is currently charging at the time of charging the battery mounted in the vehicle to improve durability of the battery while at the same time allowing the battery to charge as rapidly as possible to improve the convenience of the vehicle.

### CROSS-REFERENCE TO RELATED APPLICATION

This application claims under 35 U.S.C. §119(a) the benefit of Korean Patent Application No. 10-2011-0096715 filed on Sep. 26, 2011, the entire contents of which are incorporated herein by reference.

### BACKGROUND

(a) Technical Field

The present invention relates to a battery charging control technique for a vehicle, and more particularly, to a technology for controlling a charging operation of a battery in consideration of durability of the battery in charging the battery mounted for use in, e.g., an electric car, or the like.

(b) Background Art

Characteristics of a battery mounted for use in an electric car, or the like, to supply the energy required to drive/power a vehicle may be changed according to a temperature conditions, etc. Most of the time vehicles are operated in environments having normal temperature conditions (32-90° F.) and therefore, electrical systems in vehicles have been generally developed to meet normal temperature conditions in design thereof.

However, when a battery like the one described above is used in low temperature environments (e.g., sub-zero environments like is often seen in northern climates), the characteristics of the battery may be remarkably degraded, compared with using the battery in normal temperatures. In addition, when the same current amount is used in both normal and low temperatures, a lifespan of the battery, or the like, may be shortened if the battery is consistently used in lower temperatures due to the chemical characteristics of the battery.

In particular, when the temperature of the battery drops below a certain temperature, the lithium ion activated which generates power is remarkably slow, so that the lithium ions are precipitated (e.g., creating an Li-plating phenomenon) on a surface of an electrode in a metal lithium state, thereby leading to deterioration characteristics such as degradation of capacity, an increase in internal resistance, etc.

Conventionally, a slow charging technique has been used to charge a majority of the battery at a low current, and a rapid charging method has been applied to charge a battery within a short period of time. The slow charging entails charging the battery at a low current for a long period of time. In this case, the slow charging charges the battery at a low enough current that the phenomena, (e.g., degradation of capacity, increase in internal resistance, etc.), due to an abnormal reaction of the battery from the input current is prevented. Therefore, slow charging may be considered as a safe charging technique, however, it takes an undesirable amount of time to charge the battery.

On the other hand, the rapid charging needs to complete charging within a short period of time and thus, performs charging at higher current. Therefore, unlike the slow charging, the rapid charging is always exposed to the degradation of battery performance due to the abnormal reactions during the charging cycle, an increase in temperature during the charging cycle, etc., and there may be more fatal degradation of battery performance due to lithium (Li)-plating, or the like, when the charging is performed with high current at low temperatures.

However, since the charging needs to be completed within a reasonably short period of time in terms to ensure that the vehicle is conveniently available to the driver, it is preferable to perform the charging within a rapid time in a range in which the durability of the battery is not degraded.

The matters described as the above-mentioned background art are only to improve understanding of the background of the present invention.

### SUMMARY OF THE DISCLOSURE

The present invention has been made in an effort to provide a battery charging control technique for a vehicle configured to prevent a battery from being deteriorated by controlling charging of the battery at a current rate appropriate for a temperature environment while charging the battery mounted in the vehicle so as to improve durability of the battery. The present invention is also configured to charge as rapidly as possible so as to improve convenience of the vehicle.

In an exemplary embodiment of the present invention, a battery charging control method for a vehicle, includes: forming a map of peak (maximum) current that charges the battery according to temperature within a range in which deterioration of the battery does not occur based on whether a deterioration phenomenon of the battery occurs at each given temperature while charging at particular current rate to determine a current range in which the deterioration phenomenon does not occur at a given temperature; inputting a temperature of the battery and calculating a maximum current value from the map for the input temperature; and controlling a charging current of the battery to be within a range of the maximum current value.

In some embodiments, a control unit is configured to input a temperature of the battery and calculating a maximum current value for the input temperature from a map which forms a maximum current to be used for charging the battery according to the temperature within a current range in which a deterioration of the battery does not occur; and control charging current of the battery to be within the range of the maximum current value based on a the input temperature of the battery.

In still another embodiment, a battery charging control apparatus for a vehicle includes: an input unit configured to receive a temperature of a battery; a controller configured to include a map formed of maximum current charging for the battery according to temperature within a range in which a deterioration of the battery does not occur, calculate the maximum current from the map according to the temperature input from the input unit and determine a charging current and a charging voltage of the battery according to the calculated maximum current; and an output unit configured to control a charging operation of the battery according to the determined charging current and charging voltage by the controller.

Other aspects and preferred embodiments of the invention are discussed below.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a table testing whether a deterioration phenomenon of a battery occurs according to each temperature and a current rate of the battery in a temperature range in which a targeted battery may experience, according to a an exemplary embodiment of the present invention;

FIG. 2 is a diagram showing in a graph type a map formed of maximum current capable of charging the battery according to temperature within a range in which the deterioration of the battery does not occur and determined by using the table of FIG. 1; FIG. 3 is a flow chart showing an example of a battery charging control method for a vehicle according to an exemplary embodiment of the present invention; and

FIG. 4 is a flow chart showing an example of the battery charging control apparatus for a vehicle according to an exemplary embodiment of the present invention

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

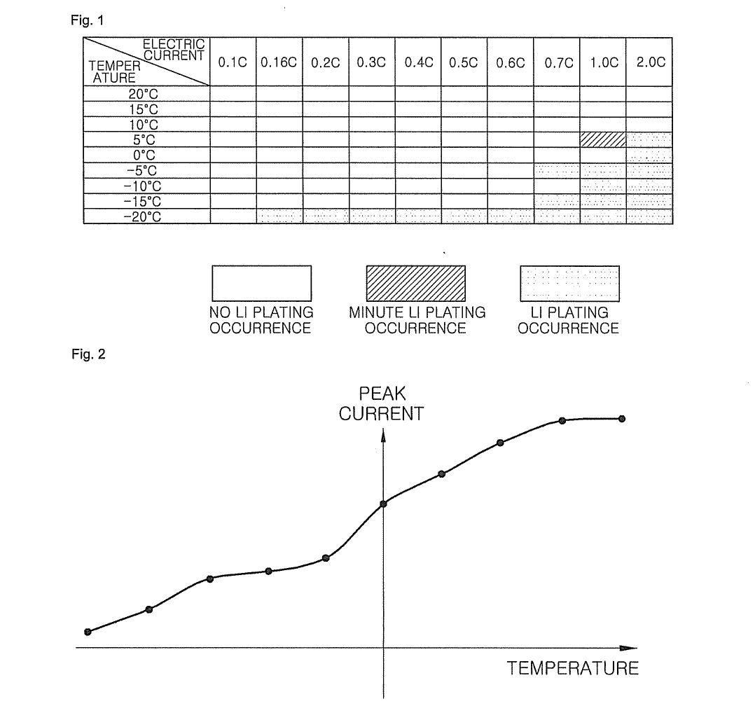

Referring to FIGS. 1 to 3, a battery charging control technique for a vehicle according to an exemplary embodiment of the present invention includes forming a map of maximum current capable of charging the battery according to temperature within a range in which deterioration of the battery does not occur based on whether the deterioration phenomenon of the battery occurs at each temperature given a particular current rate of the battery is applied in a temperature range currently being experienced by the battery (S10), inputting a temperature of the battery and calculating a maximum current value from the map for the input temperature (S20), and controlling charging current of the battery to be within a range of the maximum current value based on that input temperature (S30).

That is, the control technique according to the exemplary embodiment of the present invention tests whether the deterioration of the battery occurs or not due to a lithium precipitating phenomenon (Li-plating) when the corresponding battery is charged at a specific current rate at specific temperatures (in particularly low temperatures), obtains a maximum current capable of charging the battery without any deterioration of the battery at the present temperature of the battery based on the tested data, and charges the battery accordingly, thereby allowing implementation of the most rapid possible charging within a range in which the durability of the battery is ensured.

For reference, the current rate is defined as follows:

Current rate (A)=charging/discharging current (A)/battery rate capacity.

To form the map (S10), the temperature range of the map may be limited to a temperature range which is equal to or less than the minimum normal temperature (e.g., 32° F. or 0° C.) which a vehicle would typical experience. The reason is that this temperature range is highly unlikely to cause the deterioration of the battery at normal temperature conditions and a storage space for storing the map may thereby be minimized.

Generally, the temperature of a battery tends to be gradually increased during charging, and thus in consideration of this tendency it is preferable to control the temperature by periodically and repeatedly measuring and receiving the temperature of the battery (e.g., form a sensor). By repeatedly re-calculating (S20) the supplied current and the controlling the current supplied during the charging (S30) to reflect the temperature change of the battery according to the charging, the charging speed can be even more enhanced.

While controlling the charging to the battery (S30), the charging current of the battery may be controlled to the maximum current value to minimize the possible charging time, which contributes to improving the convenience of a vehicle. Meanwhile, the map may be substantially formed at the time of the development of the vehicle. In the actual vehicle, the charging of the battery is controlled only by the current supply calculation (S20) based on data from the map previously supplied.

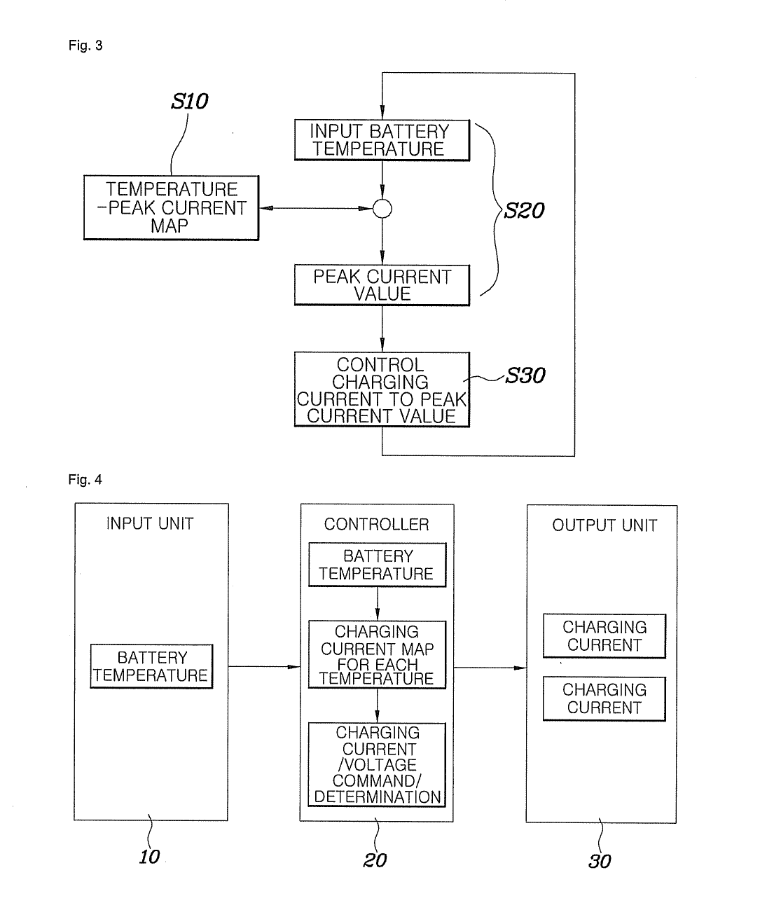

FIG. 4 is a block diagram showing an example of a battery charging control apparatus for a vehicle capable of implementing the above-mentioned function. The battery charging control apparatus includes a control unit 400 which includes a plurality of units. Illustratively, an input unit 10 that is configured to receive the temperature of the battery, and a controller 20 configured to include the map formed of the maximum current capable of charging the battery according to a temperature within the range in which the deterioration of the battery does not occur. The controller 20 also calculates the maximum current from the map according to the temperature input from the input unit 10 and determining the charging current and the charging voltage of the battery according to the calculated maximum current, and an output unit 30 controlling the charging operation of the battery according to the determined charging current and charging voltage by the controller 20.

Although the above apparatus is described as being controlled by a plurality of controllers/units, these units may be combined into any combination of units, i.e., a single controller or multiple controllers and sensors.

Further, the control apparatus configured as described above performs the charging control technique as described above so that the battery mounted in the vehicle may be more rapidly charged within the range in which the durability of the battery is not hindered under temperature conditions lower than a normal temperature.

As set forth above, the exemplary embodiments of the present invention prevents the battery from being deteriorated by controlling the current rate during charging of the battery to a current rate appropriate for the temperature environment in which the battery is currently experiencing at the time of charging to improve the durability of the battery. The illustrative embodiment of the present invention is also able to charge the battery as rapidly as possible to improve the convenience of the vehicle.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A battery charging control method for a vehicle, comprising:
forming, by a control unit, a map of maximum current over a temperature range that charges a battery in the vehicle at the current temperature of the battery without any deterioration to the battery;
inputting, the control unit, the temperature of the battery and calculating a peak current value from the map for the input temperature; and
controlling, by the control unit, charging current of the battery to be within a range of the maximum current value.

2. The method of claim 1, wherein the temperature range of the map is limited to a temperature range that is less than a minimum normal temperature at which a vehicle typically experiences.

3. The method of claim 1, further comprising controlling the temperature by periodically and repeatedly measuring and receiving the temperature of the battery, and by repeatedly re-calculating of the current applied and controlling the charging to reflect a temperature change of the battery.

4. The method of claim 1, wherein the control unit sets the charging current to the maximum current value.

5. A battery charging control method for a vehicle, comprising:
inputting, a control unit, a temperature of a battery;
calculating, by the control unit, a maximum current value for the input temperature based on a map including a maximum current range for charging the battery at the input temperature without deterioration to the battery due to the current value at the input temperature; and
controlling, by the control unit, the current supplied during charging of the battery to be within a range of the maximum current value.

6. The method of claim 5, further comprising adjusting the input temperature by periodically and repeatedly receiving new temperature measurements of the battery, and by repeatedly re-calculating the current applied and controlling the charging current applied to reflect a temperature change of the battery.

7. A battery charging control apparatus for a vehicle, comprising:
an input unit configured to receive a temperature of a battery;
a controller configured to include a map having a maximum current charging range for the battery according to a plurality of temperatures within a range in which a deterioration of the battery does not occur, and to calculate the maximum current based on the map according to the temperature input from the input unit and determine a charging current and charging voltage for the battery according to the calculated maximum current; and
an output unit configured to control a charging operation of the battery according to the determined charging current and charging voltage.
